(19) United States
(12) Patent Application Publication
(10) Pub. No.: US 2008/0270792 A1
(43) Pub. Date: Oct. 30, 2008

(54) SYSTEM AND METHOD OF ENCRYPTING AND DECRYPTING DIGITAL FILES PRODUCED BY DIGITAL STILL DEVICES

(75) Inventor: SHI-CHEN LIU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/938,494

(22) Filed: Nov. 12, 2007

(30) Foreign Application Priority Data
Apr. 29, 2007 (CN) 200710200562.0

(51) Int. Cl. H04L 9/06

(52) U.S. Cl. 713/165

(57) ABSTRACT

An exemplary system of encrypting and decrypting a digital file in a digital device is disclosed. The digital file includes an encrypting module and a decrypting module. The encrypting module includes a file-choosing block choosing a digital file to be encrypted, a code-building block producing a code for the chosen digital file and an encrypting block rendering the code for storing in the EXIF of the chosen digital file. The decrypting module includes a file-selecting block selecting an encrypted digital file, a code-taking block receiving an input code, a code-checking block comparing the input code with the code stored in the EXIF, and a decrypting block decrypting the selected file when the input code is identical to the code stored in the EXIF.

### BACKGROUND

1. Technical Field

The present invention relates to encrypting and decrypting files and, particularly, to a system of encrypting and decrypting files produced by digital still devices and a method of encrypting and decrypting the files.

2. Description of Related Art

Nowadays, digital still devices, such as digital still cameras, mobile phones with imaging function or the like, are in widespread use, and commonly can produce image, audio, or video files. The files can be saved or stored in the digital still devices, personal computers, MP3s, or USBs and can be accessed on the digital still devices and personal computers, and can even be printed out. However, the files are not protected against unauthorized access.

What is needed, therefore, is system and method of encrypting and decrypting files produced by digital still devices.

### SUMMARY

In accordance with a present embodiment, a system of encrypting and decrypting a digital file with an exchangeable image file (EXIF) and a primary file, includes an encrypting module and a decrypting module. The encrypting module includes a file-choosing block choosing a digital file to be encrypted, a code-building block producing a code for the chosen digital file and an encrypting block rendering the code for storing in the EXIF of the chosen digital file. The decrypting module includes a file-selecting block selecting an encrypted digital file, a code-taking block receiving an input code, a code-checking block comparing the input code with the code stored in the EXIF, and a decrypting block decrypting the selected file when the input code is identical to the code stored in the EXIF.

Other advantages and novel features will be drawn from the following detailed description of at least one preferred embodiment, when considered in conjunction with the attached drawings.

### BRIEF DESCRIPTION OF THE DRAWINGS

Many aspects of the present system and method of encrypting and decrypting primary files produced by digital still devices, can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a block diagram of a system with encrypting and decrypting modules, according to a preferred present embodiment.

FIG. 2 is a flow chart of encrypting files produced by digital still devices, via the encrypting module of FIG. 1.

FIG. 3 is a flow chart of decrypting files produced by digital still devices, via the decrypting module of FIG. 1.

### DETAILED DESCRIPTION OF THE PREFERRED EMBODIMENT

An embodiment of the present system and method of encrypting and decrypting files produced by digital still devices will now be described in detail below and with reference to the drawings.

Digital still devices, such as digital still cameras, mobile phones with imaging function or the like, can produce image, audio, or video files, which are called digital files in the following. Each digital file here comprises an original image, audio, or video file and an exchangeable image file (EXIF). The original image files are also called primary files in which image, audio or video contents are stored. The EXIFs generally record extra interchange information of the primary files as they are made. Most current photo manipulation software supports the reading of this information, and there are many specialized tools for reading, editing, extracting and converting EXIF information. Each EXIF has an identifying digit bit, with a first status corresponding to a public-accessible status of the corresponding primary file and a second status corresponding to an encryption status of the corresponding primary file. When the identifying digit bit is in the first status, the primary file is public-accessible; anyone can access the primary file. When the identifying digit bit is in the second status, the digital file is encrypted; the primary file can be normally accessed only after decryption of the digital file.

The system is developed in a digital device which has a digital signal processing unit, and comprises encrypting and decrypting modules to encrypt and decrypt the digital files stored in the digital device. The digital device is provided with software to assist the system to encrypt or decrypt the digital files therein. It is understood that each digital file can have its own encrypting and decrypting code. At this time, each digital file must be singly encrypted and decrypted. Feasibly, a group of digital files can have a common encrypting and decrypting code; thus, the encrypting and decrypting code can encrypt and decrypt any one digital file or a batch of digital files in the group at the same time. An example of encrypting and decrypting the digital files each having its own encrypting and decrypting code is primarily illustrated in the following. Encrypting and decrypting a batch of digital files at the same time, is similar to encrypting and decrypting a single digital file. Once the digital files are encrypted, the primary files therein cannot be normally accessed, unless the digital files are decrypted.

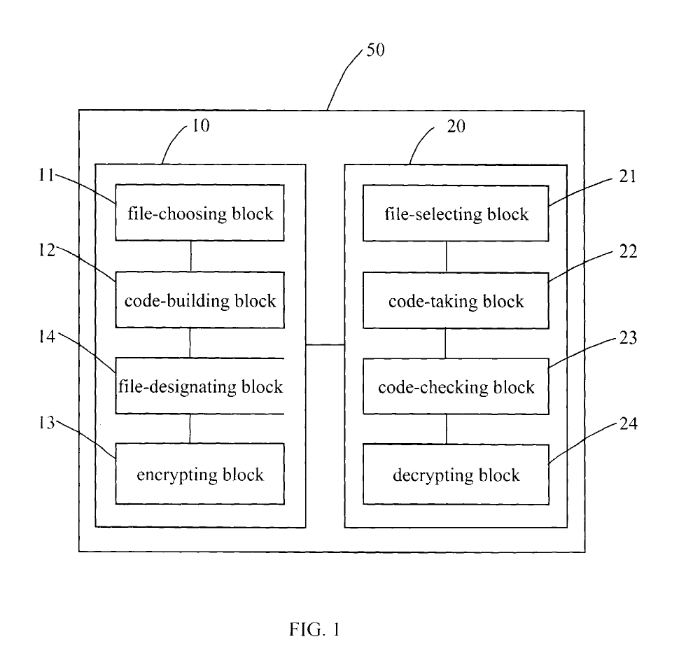

FIG. 1 is a schematic block view of a system 50 with an encrypting module 10 and a decrypting module 20, according to a preferred present embodiment. The encrypting module 10 comprises a file-choosing block 11, a code-building block 12, and an encrypting block 13. The decrypting module 20 comprises a file-selecting block 21, a code-taking block 22, a code-checking block 23, and a decrypting block 24. The encrypting module 10 and the decrypting module 20 are controlled via commands given to the encrypting module 10 via buttons, a touch panel of the digital device, blue-tooth or wireless transmitter of the digital device and so on.

The file-choosing block 11 is configured for choosing a digital file to be encrypted and setting status of the digital file to chosen. The code-building block 12 is configured to produce an encrypting and decrypting code for the chosen digital file. The encrypting block 13 stores the encrypting and decrypting code in the EXIF of the chosen digital file and sets the identifying digit bit of the exchangeable image file to the second status, so that the digital file is encrypted.

The system 50 additionally comprises a file-designating block 14. The file-designating block 14 designates an image, audio, or video file (called designated file in the following), which can be made available to a user as a substitute for the primary file of the encrypted digital file when unauthorized access of the primary file is attempted. The designated file may be a default file in the system or a file given by an authorized user of the digital device.

The file-selecting block 21 is configured to select an encrypted digital file to be decrypted in the digital device and set status of the encrypted digital file to selected. The code-taking block 22 is configured to receive an input code of the selected encrypted digital file. The code-checking block 23 checks the input code by comparing the input code with the encrypting and decrypting code stored in the EXIF of the selected encrypted digital file, and determines whether the input code is identical to the encrypting and decrypting code. If the input code is identical to the encrypting and decrypting code, the decrypting block 24 sets the identifying digit bit to the first status and deletes the encrypting and decrypting code stored in the EXIF and thus decrypts the selected encrypted digital file. If the input code is different from the encrypting and decrypting code, the decrypting block 24 fails to decrypt the selected encrypted digital file. A result of accessing the primary file of the selected encrypted digital file without the proper code is to make available the designated file rather than the primary file of the selected encrypted digital file. Once the selected encrypted digital file is decrypted, anyone can normally access it.

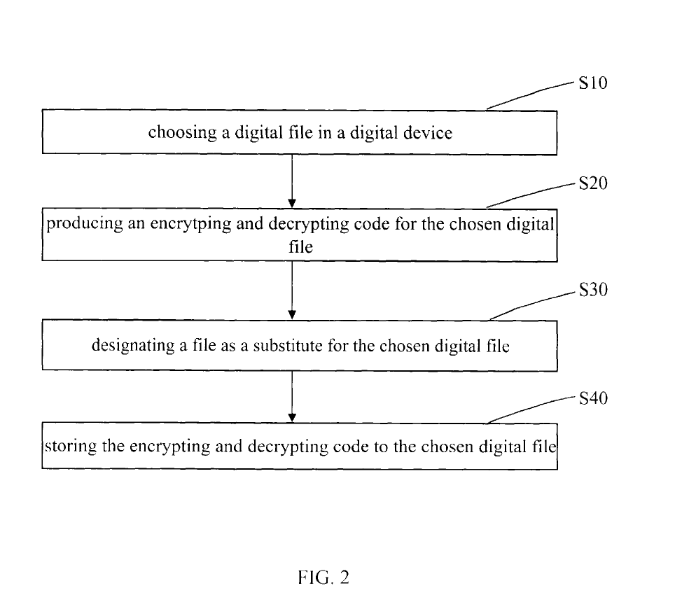

A flow chart of encrypting a digital file stored in a digital device is illustrated in FIG. 2. The detailed encrypting steps are described below.

Step S10: choosing a digital file in a digital device.

The digital file generally comprises a primary file in which image, audio, or video contents are stored, and an EXIF in which extra interchange information of the primary file is stored. The EXIF has an identifying digit bit, with a first status corresponding to a public-accessible status of the corresponding primary file and a second status corresponding to an encryption status of the corresponding primary file. When the digital device is started, the primary files stored in the digital device can be normally browsed or played. The digital file to be encrypted is chosen and set to a chosen status, according to commands received via buttons, touch panel, blue-tooth or wireless transmitter of the digital device and so on.

Step S20: producing encrypting and decrypting codes for the chosen digital file.

The encrypting and decrypting codes are produced by a code-building block according to commands received via buttons, touch panel, blue-tooth or wireless transmitter of the digital device and so on.

Step S30: designating a file in the digital device as a substitute for the primary file of the chosen digital file.

The designated file may be an image, audio, or video file which is made available to a user as a substitute for the primary file of an encrypted digital file when unauthorized access to the primary file is attempted.

Step S40: storing the encrypting and decrypting code of the chosen digital file.

The encrypting and decrypting code is stored in the EXIF of the chosen digital file and the identifying digit bit of the EXIF is set to the second status, so that the chosen digital file is encrypted. For the encrypted digital file, the primary file cannot be normally accessed. The result of accessing the primary file of an encrypted digital file without the proper code is to make available the designated file rather than the primary file.

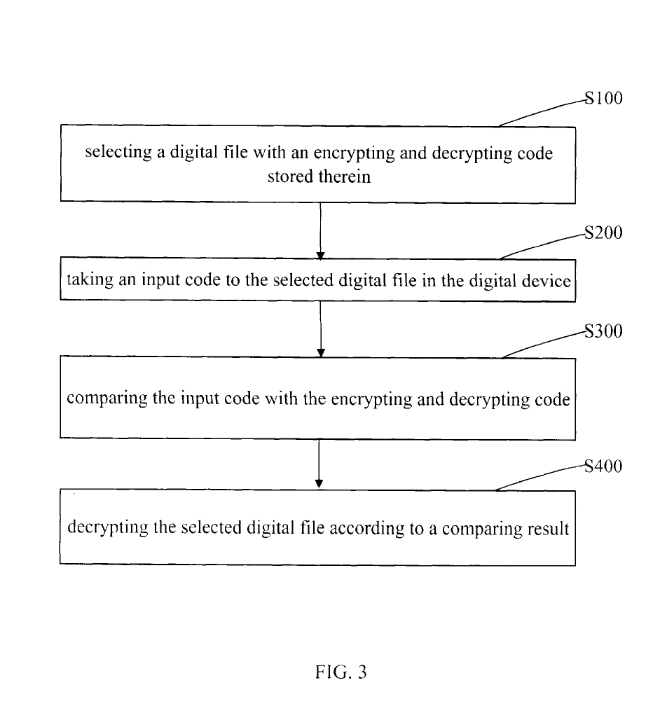

A flow chart of decrypting an encrypted digital file in the digital device is illustrated in FIG. 3. The detailed decrypting steps are described below.

Step S100: selecting a digital file with an encrypting and decrypting code stored therein.

Encrypted files in a digital device must be decrypted so that they can be accessed normally; or else, the result of accessing the primary files of the encrypted digital files without the proper code is to make available the designated file rather than the primary file. The encrypting and decrypting code is stored in an EXIF of the selected digital file. The EXIF has an identifying digit bit which is set corresponding to the encrypted status of the primary file of the digital file. The encrypted digital file to be decrypted is selected and set to selected status, according to commands received via buttons, touch panel, blue-tooth or wireless transmitter of the digital device and so on.

Step S200: taking an input code of the selected digital file.

The input code is input into the digital device from buttons, touch panel, blue-tooth or wireless transmittal of the digital device and so on.

Step S300: comparing the input code with the encrypting and decrypting code.

Comparing the input code with the encrypting and decrypting code stored in EXIF of the selected digital file, to determine if the input code is identical to the encrypting and decrypting code.

Step S400: decrypting the selected digital file according to a comparing result of Step S300.

If the input code is identical to the encrypting and decrypting code stored in the EXIF, the selected digital file is decrypted, otherwise make available the designated file rather than the primary file. To decrypt the digital file, the identifying digit bit of the EXIF is set corresponding to the public-accessible status of the primary file and the encrypting and decrypting code is deleted from the EXIF. Thus, the selected digital file can be accessed normally.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A system of encrypting and decrypting a digital file stored in a digital device, the digital file comprising an exchangeable image file (EXIF) and a primary file, the system comprising:
an encrypting module comprising a file-choosing block for choosing a digital file to be encrypted, a code-building block for producing a code for the chosen digital file and an encrypting block for storing the code in the EXIF of the chosen digital file to encrypt the chosen digital file; and
a decrypting module comprising a file-selecting block for selecting an encrypted digital file, a code-taking block for receiving an input code, a code-checking block for comparing the input code with the code stored in the EXIF, and a decrypting block for decrypting the selected encrypted digital file when the input code is identical to the code stored in the EXIF.

2. The system as claimed in claim 1, further comprising a file-designating block which designates an image, audio or video file which is made available to a user as a substitute for the primary file of the encrypted digital file.

3. The system as claimed in claim 1, wherein the EXIF has an identifying digit bit with a first status corresponding to a public-accessible status of the primary file and a second status corresponding to an encryption status of the primary file.

4. The system as claimed in claim 3, wherein the encrypting block is configured for setting the identifying digit bit to the second status.

5. The system as claimed in claim 3, wherein the decrypting block is configured for deleting the code stored in the EXIF and setting the identifying digit bit to the first status.

6. The system as claimed in claim 1, wherein the primary file is an original image, audio or video file.

7. The system as claimed in claim 1, wherein the digital device is a digital camera, or a portable phone with imaging function.

8. The system as claimed in claim 1, wherein the encrypting module and the decrypting module are controlled via commands given via buttons, touch panel of the digital device, blue-tooth or wireless transmittal of the digital device.

9. A method of encrypting a digital file stored in a digital device, the digital file comprising an exchangeable image file (EXIF) and a primary file, the method comprising:
(a) choosing the digital file in the digital device;
(b) producing an encrypting and decrypting code for the chosen digital file; and
(c) storing the encrypting and decrypting code to the EXIF of the chosen digital file.

10. The method as claimed in claim 9, further comprising (d) designating an image, audio or video file which is made available as a substitute for the primary file when the digital file is encrypted.

11. The method as claimed in claim 9, wherein the EXIF has an identifying digit bit with a status corresponding to a public-accessible status of the primary file and another status corresponding to an encryption status of the primary file.

12. The method as claimed in claim 11, wherein the step (c) comprises setting the identifying digit bit to the status corresponding to an encryption status of the primary file.

13. A method of decrypting an encrypted digital file stored in a digital device, the digital file comprising an exchangeable image file (EXIF) and a primary file, the method comprising:
(a) selecting the encrypted file with an encrypting and decrypting code stored in the EXIF thereof;
(b) taking an input code to the selected digital file;
(c) comparing the input code with the encrypting and decrypting code; and
(d) decrypting the selected digital file according to a comparing result of step (c).

14. The method as claimed in claim 13, wherein the EXIF has an identifying digit bit with a first status corresponding to a public-accessible status of the primary file and a second status corresponding to an encryption status of the primary file.

15. The method as claimed in claim 14, wherein in the step (d) deleting the encrypting and decrypting code from the EXIF and setting the identifying digit bit to the second status.

16. The method as claimed in claim 13, wherein in the step (c), determining if the input code is identical to the encrypting and decrypting code stored in the EXIF.
